(19) United States
(12) Patent Application Publication
(10) Pub. No.: US 2019/0080366 A1
(43) Pub. Date: Mar. 14, 2019

(54) INFLUENCE GROUPS FOR CONVERSIONS

(71) Applicant: Facebook, Inc., Menlo Park, CA (US)

(72) Inventors: Li Zhou, Campbell, CA (US); Aleksey Sergeyevich Fadeev, Seattle, WA (US); William Bullock, Palo Alto, CA (US); Wei Liu, San Jose, CA (US)

(21) Appl. No.: 15/699,522

(22) Filed: Sep. 8, 2017

(51) Int. Cl. G06Q 30/02; G06Q 50/00

(52) U.S. Cl. CPC G06Q 30/0277; G06Q 30/0269; G06Q 50/01

(57) ABSTRACT

A method is disclosed for attributing conversions among multiple members of a socially connected influence group, such as a household. Data from advertising impressions, including views and clicks, is maintained by an online system. When a conversion is made, the social network of the user creating the conversion event is analyzed. An influence group, defined as a group comprising the users and group of socially connected users whom influence the purchasing decisions of the first user, is created. Conversion data is analyzed for the first user and the other members of the influence group. This data is weighted to determine the propensities of successful conversions among all members of the influence group.

### BACKGROUND

The present disclosure relates generally to advertising, and specifically to a method for accurately attributing the influence that members of influence groups can have on a user's conversion decisions.

Advertisements are delivered from publishers to individual users of an online system. When a user visits a publisher's web page using a client device, publishers request advertising content from content publishers. This content is targeted to users whom fit specific demographics desired by the commercial enterprise that created the content. In order to target these users, commercial enterprises obtain demographic and geographic information from online systems. Information that is not easily ascertained by collecting data from an online system includes the types of living arrangements of users of the online system.

Individual users are often parts of influence groups. For a given influence group, many purchasing decisions are made as consensus decisions among all members of the influence group. For example, large purchases, such as houses or cars, often require input from multiple members of an influence group, e.g., a household. If a child who earns no income wants an advertised toy, he or she asks his or her parents to purchase the toy. In addition, multiple members of the household may use the same device when viewing online system advertisements. In this case, conversions could be undercounted, as a given publisher's advertisement may be viewed by multiple different people instead of by the same person multiple times. Although advertisers have straightforward methods of judging how much influence their advertisements have on consumers they directly target, they do not have straightforward methods of judging how connected users on an online system influence each other's purchasing decisions.

### SUMMARY

In an online system, data related to advertising impressions and conversions created by the online system's users is recorded and maintained. Advertisers use this data to be able to better target advertisements to online system users who would be more receptive to buying their products or services.

In general, an attribution model measures the contribution of an interaction with content by a user of an online system to a successful conversion made by that user. The model retrieves identifying information from a user performing a conversion. This information is used to retrieve interaction events associated from the user performing the conversion. The information retrieved from the interactions is weighted to determine how strongly each interaction might contribute to the conversion event. For example, an interaction occurring shortly before a conversion event may be assigned a higher weight. The degree of contribution of each interaction to the conversion event may be tabulated in a report and given to an advertiser.

The model is implemented when an action log receives a conversion event from a user, hereafter designated as the acting user. Although a conversion event can be attributed only to a single user, events causing that successful conversion may have been influenced by connected users for whom the advertiser cannot credit with the conversion. In order to assess the impact of these connected users on the successful conversion, an influence group is determined. The influence group comprises connected users that impact the acting user's propensity to make a purchase. These connected users could include family members. For instance, a husband and wife may decide to buy a house together. In another instance, a child asks his parents to purchase a toy for him. An influence group may also comprise a group of friends who want to rent a summer home. Once this group is created, interaction information from the members of the group is analyzed.

The interaction information is analyzed for all members of the influence group, including the acting user. This information, after it has been collected, is assigned weights. A hierarchy in part determines how interactions are weighted, with data relating to the acting user weighted higher than data related to the other users of the influence group. Data from clicks is weighted more heavily than data from advertisement views.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flowchart describing the process of creating and applying the attribution model in accordance with an embodiment.

FIG. 4 shows an example describing how using the attribution model influences an advertiser's decisions regarding serving advertisements to members of an influence group in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

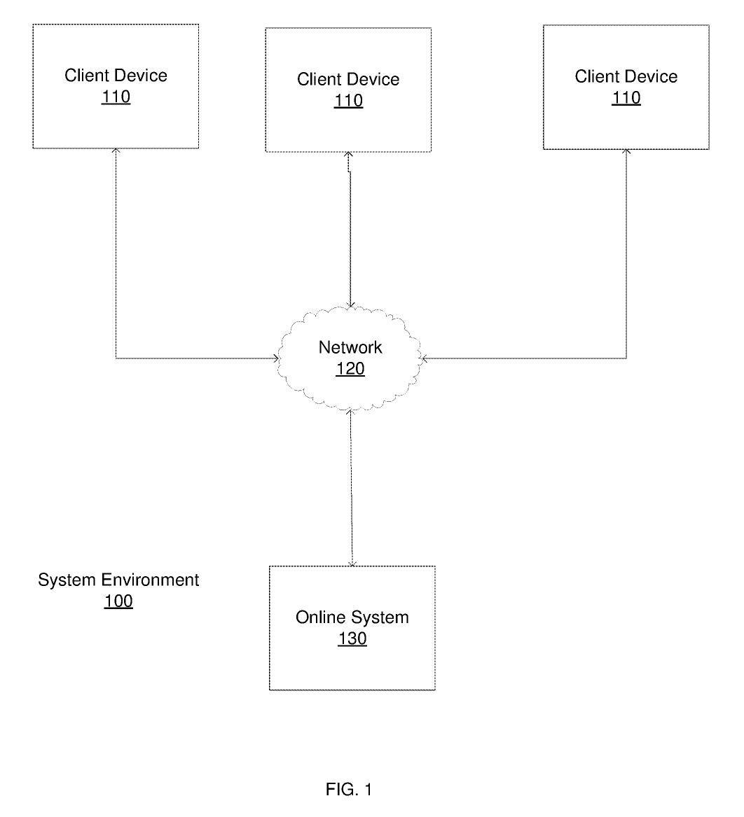

FIG. 1 is a block diagram of a system environment 100 for an online system 130 according to an embodiment. The system environment 100 shown by FIG. 1 comprises one or more client devices 110, a network 120, and the online system 130. In alternative configurations, different and/or additional components may be included in the system environment 100. For example, the online system 130 is a social networking system, a content sharing network, or another system providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the online system 130. For example, a client device 110 executes a browser application to enable interaction between the client device 110 and the online system 130 via the network 120. In another embodiment, a client device 110 interacts with the online system 130 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

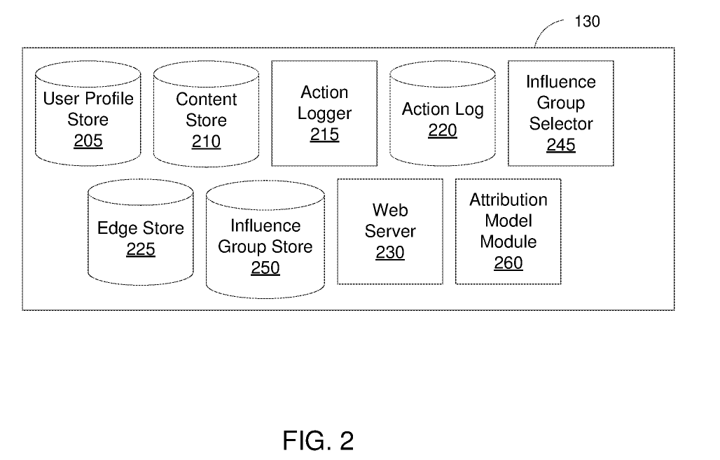

FIG. 2 is a block diagram of an architecture of the online system 130 according to an embodiment. The online system 130 shown in FIG. 2 includes a user profile store 205, a content store 210, an action logger 215, an action log 220, an edge store 225, an influence group selector 245, an influence group store 250, an attribution model module 260, and a web server 230. In other embodiments, the online system 130 may include additional, fewer, or different components for various applications. Conventional components such as network interfaces, security functions, load balancers, failover servers, management and network operations consoles, and the like are not shown so as to not obscure the details of the system architecture.

Each user of the online system 130 is associated with a user profile, which is stored in the user profile store 205. A user profile includes declarative information about the user that was explicitly shared by the user and may also include profile information inferred by the online system 130. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 130, user profiles may also be stored for entities such as businesses or organizations. This allows an entity to establish a presence on the online system 130 for connecting and exchanging content with other online system users. The entity may post information about itself, about its products or provide other information to users of the online system 130 using a brand page associated with the entity's user profile. Other users of the online system 130 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 130, events, groups or applications. In some embodiments, objects are received from third-party applications or third-party applications separate from the online system 130. In one embodiment, objects in the content store 210 represent single pieces of content, or content “items.” Hence, online system users are encouraged to communicate with each other by posting text and content items of various types of media to the online system 130 through various communication channels. This increases the amount of interaction of users with each other and increases the frequency with which users interact within the online system 130.

One or more content items included in the content store 210 include content for presentation to a user and a bid amount. The content is text, image, audio, video, or any other suitable data presented to a user. In various embodiments, the content also specifies a page of content. For example, a content item includes a landing page specifying a network address of a page of content to which a user is directed when the content item is accessed. The bid amount is included in a content item by a user and is used to determine an expected value, such as monetary compensation, provided by an advertiser to the online system 130 if content in the content item is presented to a user, if the content in the content item receives a user interaction when presented, or if any suitable condition is satisfied when content in the content item is presented to a user. For example, the bid amount included in a content item specifies a monetary amount that the online system 130 receives from a user who provided the content item to the online system 130 if content in the content item is displayed. In some embodiments, the expected value to the online system 130 of presenting the content from the content item may be determined by multiplying the bid amount by a probability of the content of the content item being accessed by a user.

In various embodiments, a content item includes various components capable of being identified and retrieved by the online system 130. Example components of a content item include: a title, text data, image data, audio data, video data, a landing page, a user associated with the content item, or any other suitable information. The online system 130 may retrieve one or more specific components of a content item for presentation in some embodiments. For example, the online system 130 may identify a title and an image from a content item and provide the title and the image for presentation rather than the content item in its entirety.

Various content items may include an objective identifying an interaction that a user associated with a content item desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the online system 130 logs interactions between users presented with the content item or with objects associated with the content item. Additionally, the online system 130 receives compensation from a user associated with content item as online system users perform interactions with a content item that satisfy the objective included in the content item.

Additionally, a content item may include one or more targeting criteria specified by the user who provided the content item to the online system 130. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow a user to identify users having specific characteristics, simplifying subsequent distribution of content to different users.

In various embodiments, the content store 210 includes multiple campaigns, which each include one or more content items. In various embodiments, a campaign in associated with one or more characteristics that are attributed to each content item of the campaign. For example, a bid amount associated with a campaign is associated with each content item of the campaign. Similarly, an objective associated with a campaign is associated with each content item of the campaign. In various embodiments, a user providing content items to the online system 130 provides the online system 130 with various campaigns each including content items having different characteristics (e.g., associated with different content, including different types of content for presentation), and the campaigns are stored in the content store.

In one embodiment, targeting criteria may specify actions or types of connections between a user and another user or object of the online system 130. Targeting criteria may also specify interactions between a user and objects performed external to the online system 130. For example, targeting criteria identifies users that have taken a particular action, such as sent a message to another user, used an application, joined a group, left a group, joined an event, generated an event description, purchased or reviewed a product or service using an online marketplace, installed an application, or performed any other suitable action. Including actions in targeting criteria allows users to further refine users eligible to be presented with content items. As another example, targeting criteria identifies users having a connection to another user or object or having a particular type of connection to another user or object.

The action logger 215 receives communications about user actions internal to and/or external to the online system 130, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 130 to track user actions on the online system 130. Users may interact with various objects on the online system 130, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 130 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 130 as well as with other applications operating on the online system 130. In some embodiments, data from the action log 220 is used to infer interests or preferences of a user, augmenting the interests included in the user's user profile and allowing a more complete understanding of user preferences.

The action log 220 may also store user actions taken on a third party system, such as an external website, and communicated to the online system 130. For example, an e-commerce website may recognize a user of an online system 130 through a social plug-in enabling the e-commerce website to identify the user of the online system 130. Because users of the online system 130 are uniquely identifiable, e-commerce websites, such as in the preceding example, may communicate information about a user's actions outside of the online system 130 to the online system 130 for association with the user. Hence, the action log 220 may record information about including webpage viewing histories, advertisements that were engaged, purchases made, and other patterns from shopping and buying. Additionally, actions a user performs via an application associated with a third party system and executing on a client device 110 may be communicated to the action logger 215 by the application for recordation and association with the user in the action log 220.

In one embodiment, the edge store 225 stores information describing connections between users and other objects on the online system 130 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 130, such as expressing interest in a page on the online system 130, sharing a link with other users of the online system 130, and commenting on posts made by other users of the online system 130.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 130, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 130 over time to approximate a user's interest in an object or in another user in the online system 130 based on the actions performed by the user. A user's affinity may be computed by the online system 130 over time to approximate the user's interest in an object, in a topic, or in another user in the online system 130 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The influence group module 245 identifies influence groups comprising the acting user and one or more groups of other users socially connected to the acting user. These socially connected users satisfy a set of criteria related to their propensities to influence the acting user's purchasing decisions. The influence groups selected by the influence group selector module 245 may have different types of influence on purchasing decisions made by the acting user. For example, a purchase may have to be a consensus decision among the members of the influence group. In another example, members of the group may be unable to make purchases, and need the acting user to make purchases for them. In another example, members of the influence group may be assigned certain purchases, but advertisers will find it useful to advertise to all members of the group in order to serve the purchasing needs of all of the members of the group.

Influence groups selected may represent many different types of relationships among the acting user and other users in the group. For example, the influence group may contain members of the acting user's household. The acting user may be a woman who decides to buy a house with her husband. Although the conversion may have occurred when the woman clicked on an advertisement for a new home, the purchasing decision is a consensus decision ultimately made by the couple. Therefore, the couple can be targeted for other purchases requiring consensus decisions between the two of them. In the case of a family, only some members may be authorized to make purchases. It is in the advertiser's best interest to make sure those members are targeted. In an example of such a scenario, a child may click an advertisement for a new online application. However, the child's parents must purchase the application for him. Therefore, the child's parents are added into the influence group containing the child. In another example, a family where both parents work may prefer to have groceries delivered to the house by a courier arranged through the use of a mobile application. These parents may choose to buy food that is both nutritious and heavily advertised to their children. Influence groups also include project teams in workplaces. For example, one member of the team may decide to purchase an item. However, a consensus among the members of the group must be reached before the purchase can be made. In general, if members of the group share resources among themselves, advertisers also benefit from running the same advertisement to all members of the group. For example, members of the group may take turns replenishing supplies, may purchase recreational equipment to share among themselves, and may purchase software licenses in bulk to save costs. A purchase by a single member of a work group affects the other members of the group. If advertisers are aware of these relationships among the members of the group, they can more easily target these users and provide all of the users with the same advertising content. Other influence groups may be self-selected by individual users of online systems. Online systems often allow users to sort their contacts into groups such as “Family” and “Close Friends.” Users tag other contacts as relatives, close friends, or significant others. Online systems also form these groups automatically by analyzing their users' profile data. Groups are formed by analyzing the frequency and types of interaction between users. Users that interact more frequently may be more likely to influence each other's purchasing decisions. For example, a user might download a popular online game upon clicking on an advertisement for that game served on the online system. The advertiser may decide to target an influence group comprising the user's “Close Friends” and advertise the game to these users, as the converting user's friends are likely interested in playing the game with him or her. The “Close Friends” group may be a curated set of users with whom the converting user is socially connect, or it may be a group of people with whom the converting user interacts the most on the online system. The advertiser knows to target all of these users whenever new games are released or updates to existing games are available. In this scenario, the advertiser hopes to maximize the amount of users playing the game that the advertiser is advertising.

In one embodiment, influence groups are determined based on affinity ratings. Users in the online system are assigned affinity ratings and/or weights with respect to one another. Affinity ratings are affected by users' stated relationships with one another, how often users interact with one another, and whether users share stated interests. Affinity ratings can also be assigned to users with respect to online system content. For example, if a user denotes that another user of the online system is his wife, his affinity score for that user increases. If one user regularly posts links to online system content on a connected user's profile page, that user's affinity score for the other user increases. If two users both state that they enjoy hiking on their online system profiles, their affinity scores for one another increase. In addition, if a user enjoys running, he or she may “like” online system pages related to running. He or she may post links to content associated with running on his or her online system page. He or she may state a like for running on his or her profile. All of these actions will increase his or her affinity scores for other users whom also enjoy running as an activity. In this embodiment, an influence group is determined by curating a list of connected online system users whose affinity scores exceed a threshold affinity score. Users with higher affinity to an acting user are likely to respond in similar ways to advertisements displayed on the online system by a given advertiser.

The influence group store 250 stores information about one or more influence groups for all users of the online system, including an acting user, once the group is selected by the influence group selector 245. The influence group store 250 stores one or more influence groups for users of the online system. In the preceding examples, it was shown that influence groups can exist for arrangements including households and professional groups. It is easy to see that a given user may be a member of multiple influence groups. For example, a user may have an influence group comprising his family, a separate influence group comprising his co-workers, and a third influence group comprising his close friends. Advertisers promoting different types of products could target members of each of these three groups.

The attribution model described herein is a set of rules that allows the advertiser to leverage the influence group information stored by the influence group store 250 to target members of these groups to maximize the numbers of conversions seen by these different types of advertisers. A conversion is logged by the action logger 215 and stored in the action log 220. Information identifying an acting user is retrieved by the online system from the conversion event. This information could include a user identifier, a client identifier, and an application identifier. Interactions with the advertisement are also logged and stored in the action log 220. The same types of identifiers are used to associate these interactions with the acting user. In addition, information regarding the acting user's influence group is determined. Interactions with the advertising content from members of the group also is retrieved. This interaction information is used to determine the contribution of each group member to the conversion.

The attribution model module 260 analyzes the conversion and impression history of all the users in the influence group using the attribution model. The impression history taken is dependent on the user for which the impression history is taken or the type of product advertised. The impression history is taken from a specified time frame. In one embodiment, for the active user in the influence group, the attribution model module 260 analyzes the impression data from the previous day and the click data from the previous seven days. For other users in the group, click data may be taken from the previous month. This may occur, for example, in a household when a child has been pining for a certain gift for months, but is unable to purchase the gift himself. The child expresses his wishes to a parent, who vacillates for a week before finally purchasing the gift . . . In another embodiment, impression data could be analyzed for months at a time. Analyzing this data could be useful in an example where a married couple is looking to purchase airline tickets, but only one partner clicks on the advertised booking. Because finding the best flight for a vacation can be a long process and take weeks or months of planning, it may be important to analyze a longer impression history. This way, the advertiser has better information regarding which group member (partner) to target with offers for flights in the future.

These different types of impression data are weighted using a hierarchical structure. In one embodiment, clicks from the acting user may receive the highest weight when being incorporated into the attribution model. Impressions from the acting user may receive the next-highest weight. Clicks from other members of the influence group receive lower priority, and impressions from other members of the influence group receive the lowest priority. Affinity also contributes to the weighting. For example, influence group members with higher affinity for the product of service the publisher is advertising would have increased weight in the conversion decision. Members of the influence group with higher affinity ratings for the acting user, or vice-versa, would be weighted more heavily when calculating their contributions to the conversion decision. Attribution weights also vary based on the type of influence group used. For example, family members might be more closely associated than work colleagues. Therefore, weights among members of a household group may be higher for all members of the group than weights among work colleagues. A consequence of this might be that the acting user in the work group has more influence on the successful conversion attributed to himself or herself than would the acting user in a household influence group. The attribution model module 260 also takes into account whether the connected users share a browser or connected device. Summing the propensities to convert from multiple connected users shows advertisers whether a conversion is more likely to occur for at least one member of the influence group.

The web server 230 links the online system 130 via the network 120 to the one or more client devices 110. The web server 230 serves web pages, as well as other content, such as JAVA®, FLASH®, XML and so forth. The web server 230 may receive and route messages between the online system 130 and the client device 110, for example, instant messages, queued messages (e.g., email), and text messages, short message service (SMS) messages, or messages sent using any other suitable messaging technique. A user may send a request to the web server 230 to upload information (e.g., images or videos) that are stored in the content store 210. Additionally, the web server 230 may provide application programming interface (API) functionality to send data directly to native client device operating systems, such as IOS®, ANDROID™, or BlackberryOS.

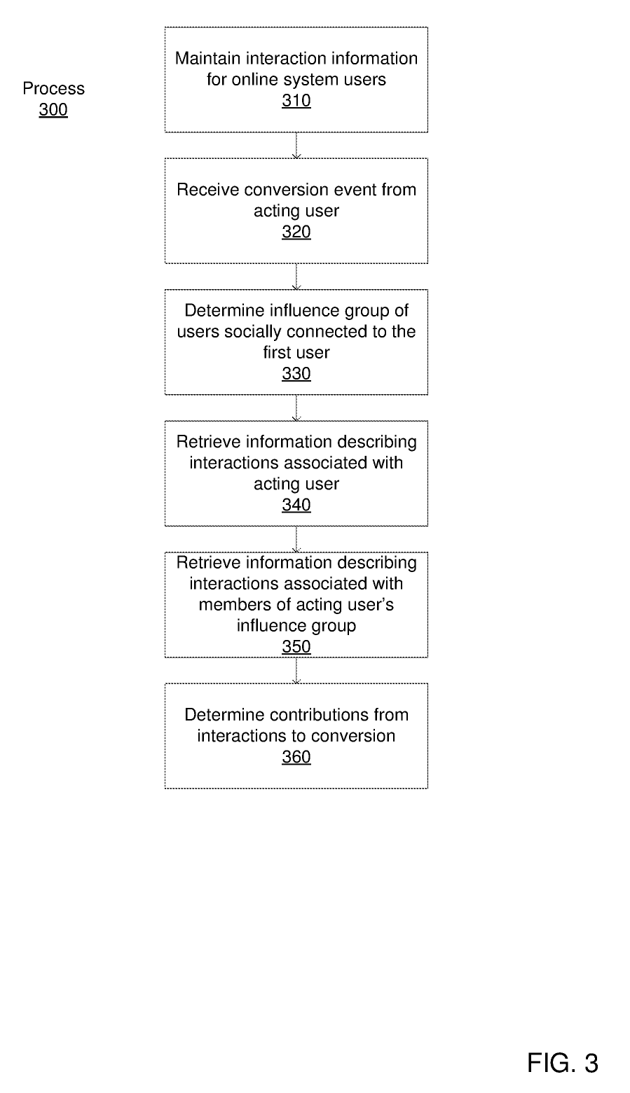

FIG. 3 is a flow chart of one embodiment of a method for determining contributions of various interactions from members of an influence group to a conversion associated with an advertisement sent to that group. In other embodiments, the method includes different, additional, or fewer steps than those depicted in FIG. 3. Additionally, in some embodiments, the steps described in conjunction with FIG. 3 may be performed in a different order.

Additionally, the online system 130 maintains 310 information describing one or more interactions associated with a user of the online system 130. For example, the online system 130 receives 310 information via a tracking pixel embedded in an advertisement indicating a user of the online 130 system was presented with the advertisement, identifies the user with an online system user identifier, a browser identifier, and a client device identifier, and indicates the time that the user was presented with the advertisement. The information describing user interactions may be received in real-time or in near real-time. Interactions associated with users of the online system are stored in the user profile store 205. In some embodiments, the online system 130 maintains 310 information describing interactions associated with entities that are not users of the online system 130. For example, the online system 130 maintains 310 information identifying an interaction with an advertisement, a timestamp associated with the interaction, and a client device identifier associated with the client device 110 used to perform the interaction

The online system 130 receives 320 information describing a conversion associated with an advertisement and associated with an acting user. As described above, a conversion is a type of action associated with the advertisement by an advertiser as a desired type of interaction in response to presentation of the advertisement. Examples of a conversion include a purchase, an interaction with an advertisement, or other suitable interaction associated with the acting user of the online system 130 and an advertisement. The information describing the conversion may be received 320 from a tracking pixel or other tracking mechanism on a third-party system 130 or from any suitable source. Additionally, the information describing the conversion may be received in real-time or in near real-time. This conversion information is logged by the action logger 215 Information describing the conversion includes information identifying the acting user (e.g., an online system user identifier, a client device identifier, and an application identifier), a description of the conversion, and a time associated with the conversion. The online system 130 stores the information describing the conversion. For example, the online system 130 stores information describing the conversion and other interactions associated with an advertiser associated with the conversion in a write-optimized database in the action log 210.

The online system also keeps a record of connections among users for the purpose of forming influence groups 330. This connection record is stored by the edge store 225. Each identified user is socially connected to a plurality of additional users of the online system. The user may have strong associations to members of this group of connected users. For example, a plurality of users within the connected group may be members of the user's immediate family, household, or influence group. A separate plurality may contain the user's coworkers or users with whom he or she is working on a project. These subgroups of users influence the purchasing decisions of the acting user. The online system identifies these as influence groups.

Information describing one or more interactions with the advertisement associated with the acting user is retrieved 340 using the information identifying the acting user. Additionally, in some embodiments, multiple types of information describing interactions associated with the acting user are identified. For example, if the information identifying the acting user is a device identifier, the online system retrieves 340 interactions associated with the other types of information identifying the acting user along with interactions associated with the device identifier. The information is retrieved, for example, from the action log 220.

Information describing one or more additional interactions with the advertisement associated with each of the members of the acting user's influence group is next retrieved 350 using the information identifying the members of the acting user's influence group. The identifying information used is of the same nature as the type used to identify the acting user. As in 340, this information is retrieved from the action log 220.

Based on the retrieved information describing the interactions, the online system 130 communicates the interactions to the attribution model module 260, which determines a contribution value of various interactions to the conversion by implementing an attribution model. Weights are associated with various interactions from the retrieved information. In one embodiment, a weight is associated with each interaction described by the retrieved information. A weight associated with an interaction provides a measure of the amount a contribution of the interaction should make toward the conversion.

In various embodiments, a weight associated with an interaction is based at least in part on a type of information identifying the user associated with the interaction. User profile information stored by the user profile store 205 contains stated relationships between members of the influence group. Stated relationships also affect how interactions are weighted. For example, a publisher posts home advertisements that are read by members of a household influence group. The influence group members list their relationships to one another on their online system profile pages. The attribution model module 260 determines that interactions from a mother and father should weighted more heavily than those from the children.

In some embodiments, the online system 130 determines the weights associated with various interactions and communicates information describing the weights and the interactions to the attribution model module 260 which determines 360 the contribution value of various interactions to the conversion based at least in part on the weights. In some embodiments, the online system weights the various interactions based on other information associated with the user and/or the interaction (e.g., a length of elapsed time since the interaction and a time when the conversion occurred). For example, interactions that occur shortly before the conversion itself are likely to be more salient than interaction events that occur further in the past. If a child clicks on an athletic shoe ad, and then has a parent purchase the shoe a year later, it is likely that the impression that occurred a year previous to the conversion did not directly impact the conversion itself.

In some embodiments, whether the acting user or a member of the acting user's influence group performed the interaction to influence the weight of the interaction. For example, interactions undertaken by the acting user may be weighted more heavily than those undertaken by a member of the acting user's influence group. Different types of interactions among members of the group are also weighted differently in the attribution model. For example, advertisement clicks are weighted more heavily than advertisement views. Depending on the model parameters, an advertisement view by the acting user may be weighted less heavily than a click by a member of the acting user's influence group.

This information is used by the attribution model to determine a hierarchy that is used by the advertiser to prioritize sending advertisements. For example, an advertiser knows which user performed the conversion and to which influence groups the user belongs. The advertiser can use this knowledge to make an informed decision to best allocate advertisements to both the acting user and the acting user's online network. For example, within the hierarchy, the interactions by the acting user are prioritized over those by other members of the influence group, and the acting user is therefore sent more advertisements through the online system. Within the influence group itself, members who performed certain types of interactions may be sent more advertisements than others. For example, influence group members who clicked on advertisements may be served more advertisements than influence members who merely viewed them. Combining these rules, therefore, yields the following ranking, from most to least important: clicks from the acting user, views from the acting user, clicks from other influence group members, and, finally, views from other influence group members.

In one embodiment, the attribution model is configured to weight users based on affinity ratings. Users are given affinity ratings for content on the online system and for other users with whom they are connected. For a given user, multiple factors contribute to an increased affinity rating for a particular user or for particular online system content. For example, if two close friends interact frequently using the online system, e.g., by sharing links, videos, or other content with one another, the mutual affinity ratings for both users increase. If a particular user “likes” a particular page or a link to sponsored content posted on his or her news feed, that user's affinity rating for that piece of content increases. Users within the influence group with higher affinity ratings for the acting user are given higher weights than users with lower affinity ratings. This is because it is more likely that users with similar habits or stronger relationships to the acting user would influence the acting user's purchasing decisions. For example, two brothers are in an influence group. They post links to audio content on each other's news feeds frequently, and regularly attend events together. They have high affinity ratings for each other and for the same specific musical acts. In the event of a successful conversion event wherein one of the brothers purchases a concert ticket, the attribution model rules would weight interactions with concert ticket advertisements from both brothers heavily. A click on an advertisement from one of the brothers may be more heavily weighted than a click from the brothers' mother or father, who may not share the same taste in music.

Once the weights are associated with the user interactions, an attribution model or one or more attribution rules are applied by the attribution model module 260 to the interactions corresponding to the retrieved information to determine 360 contributions of various interactions to the conversion. The attribution rules or attribution model include the weights associated with various interactions when determining 360 contributions of various interactions to the conversion. As another example, interactions associated with a type of information identifying the acting user having at least a threshold confidence value are provided to the attribution model. In various embodiments, the contribution of an interaction to the conversion is based at least in part on a weight associated with the interaction. In these embodiments, the weights associated with the interactions are dependent at least partially upon whether the acting user or a member of the acting user's influence group performed the interaction.

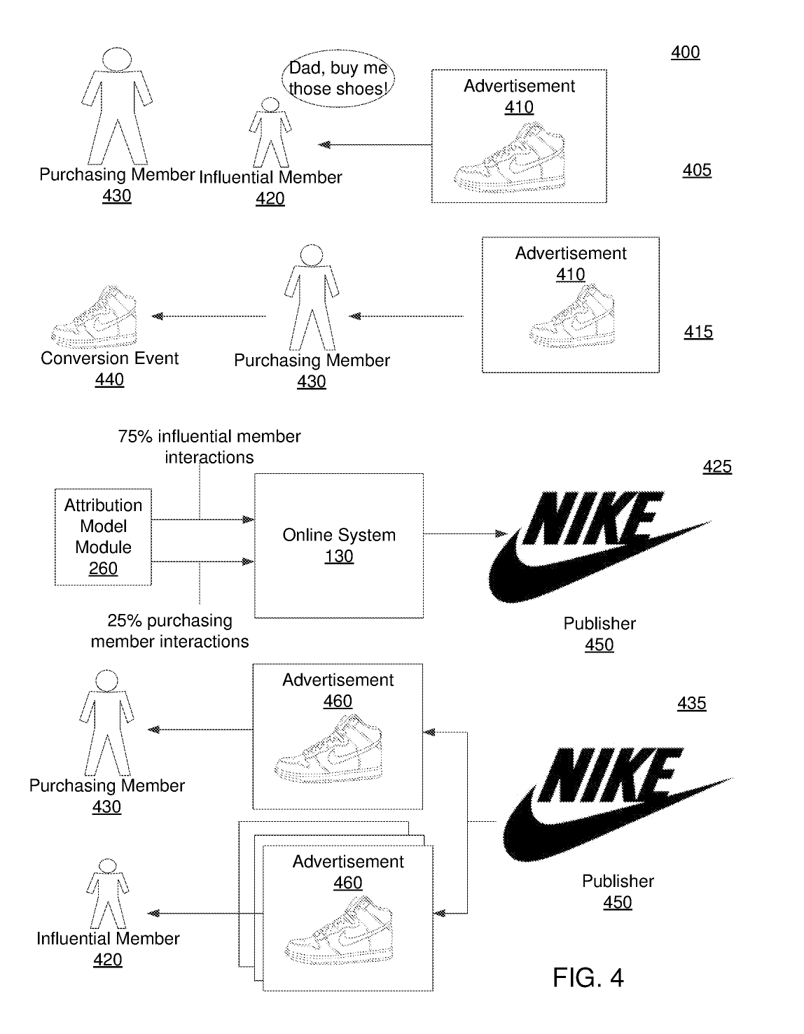

FIG. 4 shows an example of using the attribution model influences an advertiser's decisions regarding serving advertisements to members of an influence group according to an embodiment. The influence group in this example is a household, comprising influential member 420 and a purchasing household member 430. In one embodiment, the acting user is a male child and an important household member is the child's father. The influential member 420 and purchasing member 430 interact with an advertisement 410 which is delivered by a publisher 450.

The influential member 420 is an active user of the online system 130. While browsing his news feed, the influential member 420 sees 405 an advertisement 410 for athletic shoes delivered by the advertisement publisher 450. The influential member 420 decides that he wants to purchase the shoes. The influential member 420 is not of age to purchase the shoes, so the user summons an older household member, the purchasing member 430, to purchase the shoes. In this embodiment, as stated earlier, the influential member 420 is a son and the purchasing member 430 is his father. The purchasing member 430 clicks on the served advertisement 410 and purchases the pair of shoes. This purchase is logged 415 as a successful conversion event 440. This influential member 420 is designated as the acting user, as he is the user that performed the successful conversion event 440.

Since the pair of shoes purchased is a pair of children's athletic shoes marketed to young boys, an appropriate influence group to select would be an influence group containing members of the purchasing member 430's household. The online system maintains data on the purchasing member 430, including the purchasing member 430's stated relationships with connections on the online system 130. For example, the purchasing member 430 is a father and the influential member 420 is his son, in one embodiment. The publisher 450 is NIKE®. Information also maintained by the online system 130 includes affinity ratings users have for one another. For example, the son of the family has high affinity ratings for sports-related content. The father and son have higher affinity ratings for one another than they do with other members of the family. NIKE® also determines that, although the husband purchased the pair of shoes and successfully made the conversion upon a first viewing, the son clicked the NIKE® shoe advertisement three times in the last week.

The attribution model module 260 uses the advertisement interaction data for the users in this group and applies rules 425 from the attribution model to weight these interactions and determine how heavily each of these interactions contributed to the successful conversion by the purchasing member 430, or father in the household example. In order to do this, the module leverages data discussed in the preceding paragraph, such as affinity ratings for content and among the users in the group. The module also leverages the type and frequency of interactions with the advertisement 410. In this embodiment, the attribution model module 260 determines, for example, that 75% of the conversion is attributed to the influential member 420 and 25% is attributed to the purchasing member 430. The attribution model module 260 delivers this information to the publisher 450 (NIKE® in the household example discussed).

In general, an advertiser is indifferent to whether a specific user in the influence group executes a successful conversion. However, the advertiser is more likely to achieve higher conversion rates for at least one member of the influence group if the advertiser knows that targeting any member of the influence group is more likely to yield a conversion. For an influence group that is family, this behavior could include providing each member of the family with advertisements for child-friendly nutritious foods or popular family vacation destinations. For consensus purchases, each member of the family could be served the same ad, allowing members of the family to convince each other to decide to make the important purchase. For an influence group that is an office group, each member of the group could be served ads specific to the products the group members need in order to complete their project. They could also be served ads relating to bulk software license deals or office supplies that are more cheaply sold to groups. The illustrative example of FIG. 4 shows that the publisher 450 allocates advertisements to users within influence groups optimally to ensure that a conversion event (such as the conversion event 440) does occur.

Using the delivered information, the publisher 450 determines 435 an optimal way to serve shoe advertisements to the members of the influence group, including the influential member 420 and the purchasing member 430. Using the household example, the son would receive a large volume of shoe advertisements, while the father would receive a moderate amount of advertisements on the online system. This is described in the figure, where the purchasing member 430 is shown to receive a lower volume of advertisements than the influential member 420. Future conversions may cause the publisher 450 to shift the allocation of advertisements to members of the influence group. In the household example, it may happen that the father begins purchasing a large volume of shoes, even though the son is not interacting with as many advertisements. NIKE® may shift allocation of advertisements in response to this to deliver more shoes to the father. This would mean that the attribution process is conducted multiple times after set intervals of time.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method, comprising:
maintaining interaction information for a plurality of users of an online system with advertised content associated an advertiser, wherein interaction information for each interaction identifies a user associated with the interaction, a description of the type of the interaction, and a time associated with the interaction;
maintaining group information for the plurality of users of the online system, the group information identifying one or more influence groups, each influence group comprising connections of a user of the plurality who are likely to influence the user's conversion behavior;
responsive to logging a conversion event associated with the advertiser by an acting user of the plurality of users:
retrieving from the maintained interaction information, interactions by the acting user with the advertised content during a first predetermined time period prior to the conversion event;
retrieving from the maintained group information, an influence group associated with the acting user; and
retrieving from the maintained interaction information, interactions by the connections of the acting user with the advertised content during a second predetermined time period prior to the conversion event;
applying an attribution model to the interactions by the acting user and influence group with the advertised content, wherein applying the attribution model assigns to each interaction a weighted contribution to the conversion event.

2. The method of claim 1, wherein the attribution model outlines a hierarchy for attributing contributions to the conversion event, wherein click interactions from the acting user are ranked highest, view interactions from the acting user are ranked second highest, click interactions from an influence group member are ranked third highest, and view interactions from an influence group member are ranked fourth highest.

3. The method of claim 1, wherein interactions by users who have publicly stated, on the online system, interest in content related to the advertised content are weighted more heavily.

4. The method of claim 1, wherein interactions by users for whom the acting user has a higher affinity rating are weighted more heavily.

5. The method of claim 2, wherein the advertised content is served to the members of the influence group who make the most heavily weighted contribution to the conversion.

6. The method of claim 1, wherein the influence group comprises one of a group of family members, a team of employees, or a group of close friends.

7. The method of claim 1, wherein determining the contribution of each of the identified one or more interactions of the acting user and the associated household to the conversion includes weighting interactions by type and by user.

8. The method of claim 1, wherein interactions by the acting user are weighted more heavily than by interactions by the other members of the household.

9. The method of claim 1, wherein interactions that occur temporally closer to the conversion event are weighted more heavily.

10. The method of claim 1, wherein the frequency of interactions between the active user and a connected online system user is a criterion for the connected user's placement in the household.

11. The method of claim 1, wherein the placement of both the active user and a connected online system user into a named subset of online system users is a criterion for the connected user's placement in the influence group.

12. The method of claim 7, wherein the named subset could comprise the categories “Work”, “Family” and “Close Friends”.

13. The method of claim 1, wherein common named interests, personalities, or online system pages tagged between the active user and a connected online system user is a criterion for the connected user's placement in the influence group.

14. The method of claim 1, wherein the interactions comprise clicks and views.

15. The method of claim 15, wherein clicks taking place within a specified timeframe and views are stored taking place within another distinct specified timeframe.

16. The method of claim 16, wherein the timeframe for views is longer than the timeframe for clicks.

17. A computer program product comprising a computer-readable storage medium having instructions encoded therein that, when executed by a processor, cause the processor to:
receive information describing one or more interactions of one or more users of an online system with content associated with one or more advertisers, the information describing each interaction identifying a user associated with an interaction, a description of the type of the interaction, and a time associated with the interaction;
store the received information in one or more logs, each of the one or more logs associated with the advertiser;
responsive to receiving information describing a conversion associated with the advertiser and identifying an acting user;
identify an associated household of users connected to the user in the online system, wherein the associated household comprises connections who are likely to influence the acting user's decision to perform the successful conversion;
store interaction information of the members of the associated household with the advertised content; and
determine the contribution of each of the identified one or more interactions of the acting user and the associated household to the conversion by applying one or more rules to the identified one or more interactions.

18. The computer program product of claim 18, wherein a household comprises one of a household, a team of employees, or a group of close friends.

19. The computer program product of claim 18, wherein determining the contribution of each of the identified one or more interactions of the acting user and the associated household to the conversion includes weighting interactions by type and by user.

20. The computer program product of claim 20, wherein interactions by the acting user are weighted more heavily than by interactions by the other members of the household.

21. The computer program product of claim 18, wherein interactions that occur temporally closer to the conversion event are weighted more heavily.

22. The computer program product of claim 18, wherein the frequency of interactions between the active user and a connected online system user is a criterion for the connected user's placement in the household.

23. The computer program product of claim 18, wherein the placement of both the active user and a connected online system user into a named subset of online system users is a criterion for the connect user's placement in the household.

24. The computer program product of claim 24, wherein the named subset could comprise the categories “Work”, “Family” and “Close Friends”.
